(19) United States
(12) Patent Application Publication
(10) Pub. No.: US 2012/0229416 A1
(43) Pub. Date: Sep. 13, 2012

(54) ELECTROSTATIC CAPACITY TYPE TOUCH SCREEN

(76) Inventors: Ja-Seung KU, Yongin-City (KR); Brent JANG, Yongin-city (KR); Do-Youb KIM, Yongin-city (KR); Soon-Sung AHN, Yongin-city (KR)

(21) Appl. No.: 13/226,970

(22) Filed: Sep. 7, 2011

(30) Foreign Application Priority Data
Sep. 7, 2010 (KR) 10-2010-0087521

(51) Int. Cl. G06F 3/044

(52) U.S. Cl. 345/174

(57) ABSTRACT

An electrostatic capacity type touch screen included in an image display apparatus is provided. The electrostatic capacity type touch screen includes an active touch region on a screen divided into a plurality of regions and a plurality of conductive sensing patterns formed in the divided regions to detect capacitance. Coupling of the conductive sensing patterns among the divided regions is broken.

### BACKGROUND

1. Field

Embodiments relate to an electrostatic capacity type touch screen provided in an image display apparatus.

2. Description of the Related Art

A touch screen is an input apparatus through which a user command may be input by selecting instruction contents displayed on a screen by a finger of a person or an object. The instruction contents are displayed on a screen from an image display apparatus.

The touch screen is provided on the front surface of the image display apparatus to convert a contact position into an electric signal. The contact position is the position at which the finger of the person or the object directly makes contact with the touch screen. Thus, the instruction contents selected at the contact position is regarded as an input signal.

A separate input apparatus may be coupled to an image display apparatus. Since the touch screen may replace a separate input apparatus, such as a keyboard and a mouse, the range of the touch screen gradually increases.

The touch screen may be accomplished by certain known types, such as a resistance layer type, a photosensitive type, and an electrostatic capacity type.

The electrostatic capacity type touch screen senses a change in electrostatic capacity that a conductive sensing pattern forms with another peripheral sensing pattern or ground electrode. This change in electrostatic capacity occurs when a finger or an object contacts the touch screen to convert a contact position into an electric signal.

Therefore, the electrostatic capacity type touch screen includes a plurality of first sensing patterns formed to be coupled to each other in a first direction and a plurality of second sensing patterns formed to be coupled to each other in a second direction. The second direction of the second sensing patterns intersects the first direction of the first sensing patterns to grasp the coordinates of the contact position.

As the electrostatic capacity type touch screen is enlarged, the length by which the first sensing patterns are coupled to each other and the length by which the second sensing patterns are coupled to each other increases so that base capacitance caused by parasitic capacity of electrodes or signal lines of a display panel below the touch screen increases. Thus, touch sensitivity deteriorates.

### SUMMARY

Embodiments are therefore directed to a touch screen, which substantially overcome one or more of the problems due to the limitations and disadvantages of the related art.

It is therefore a feature of an embodiment to provide an electrostatic capacity type touch screen panel with conductive sense patterns formed in a plurality of diamond patterns, such that the electrostatic capacity touch screen panel is capable of preventing touch sensitivity from deteriorating as the touch screen is enlarged.

It is therefore another feature of an embodiment to provide an electrostatic capacity type touch screen panel with conductive sense patterns formed in a plurality of triangle bar electrode pairs, such that the electrostatic capacity touch screen panel is capable of preventing touch sensitivity from deteriorating as the touch screen is enlarged.

At least one of the above and other features and advantages may be realized by providing an electrostatic capacity type touch screen, including an active touch region on a screen divided into a plurality of regions and a plurality of conductive sensing patterns formed in the divided regions to detect capacitance. Coupling of the conductive sensing patterns among the divided regions is broken.

The electrostatic capacity type touch screen further includes a plurality of capacitance sensing units for sensing capacitances of the divided regions and a coordinate detecting unit for collecting capacitance information output from the plurality of capacitance sensing units to detect a position of a touch point.

The plurality of capacitance sensing units sense capacitances of corresponding regions to output as digital values and the coordinate detecting unit synthesizes the digital values output from the capacitance sensing units to calculate coordinate values of a touch point.

The conductive sensing patterns include a plurality of first sensing patterns coupled in the divided regions in a first direction and a plurality of second sensing patterns coupled in the divided regions in a second direction.

The first sensing patterns have a plurality of diamond patterns coupled to each other in the first direction and the second sensing patterns have a plurality of diamond patterns coupled to each other in the second direction.

At least one of the above and other features and advantages may also be realized by providing conductive sensing patterns realized by a plurality of triangle bar electrode pairs arranged to face each other, to cross each other, and to be engaged with each other.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plan view schematically of an electrostatic capacity type touch screen according to an embodiment;

FIG. 2 illustrates a block diagram of the position detecting apparatus of the touch screen of FIG. 1;

FIG. 3 illustrates a schematic plan view of an electrostatic capacity type touch screen according to another embodiment; and

FIG. 4 illustrates a block diagram of the position detecting apparatus of the touch screen of FIG. 3.

### DETAILED DESCRIPTION

Korean Patent Application No. 10-2010-0087521, filed on Sep. 7, 2010, in the Korean Intellectual Property Office, and entitled: “Capacitive Touch Screen” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

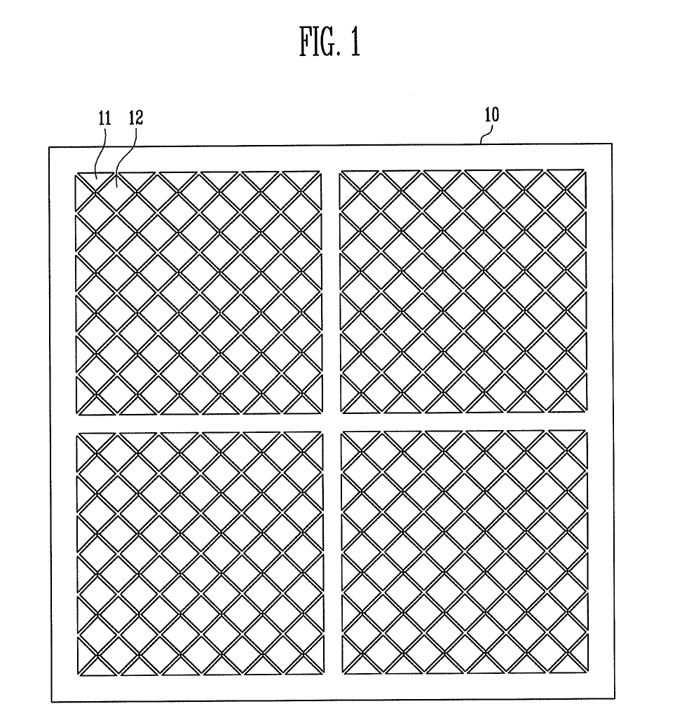

FIG. 1 is a plan view schematically illustrating an electrostatic capacity type touch screen according to an embodiment. Referring to FIG. 1, the electrostatic capacity type touch screen according to the present embodiment includes a transparent substrate 10, and a plurality of conductive sensing patterns 11 and 12 formed on the transparent substrate 10.

According to the present embodiment, the conductive sensing patterns 11 and 12 are formed so that an active touch region on a screen capable of sensing a touch input is divided into a plurality of regions and is realized in the form of tiling. The active touch region on the screen is divided into a plurality of regions and the plurality of conductive sensing patterns 11 and 12 for detecting capacitance are formed in the divided regions. For example, the active touch region on the screen is divided into a 2×2 matrix, i.e. two up and down and side to side regions, respectively. As illustrated in FIG. 1, the active touch region may be divided into four regions.

Therefore, coupling among the conductive sensing patterns 11 and 12 that belong to different regions is broken. In particular, electric coupling among the conductive sensing patterns 11 and 12 is broken. According to the example embodiment, coupling of the conductive sensing patterns 11 and 12 in the divided regions is broken so that the electrostatic capacity type touch screen is realized in the form of tiling.

The conductive sensing patterns 11 and 12 include first sensing patterns 11 coupled in the divided regions in a first direction and second sensing patterns 12 coupling in the divided regions in a second direction. The first direction and the second direction are different directions. For example, when the first direction is set as a column direction, the second direction may be set as a row direction.

The first sensing patterns 11 and the second sensing patterns 12 are formed of a transparent electrode material such as indium tin oxide (ITO) to have a pattern in which the first sensing patterns 11 and the second sensing patterns 12 are close to each other. The first sensing patterns 11 are coupled to each other in the first direction and the second sensing patterns 12 are coupled to each other in the second direction.

For example, the first sensing patterns 11 and the second sensing patterns 12 are formed in the diamond patterns illustrated in FIG. 1. The diamond patterns may be coupled to each other in the first direction and the second direction.

Therefore, the first sensing patterns 11 and the second sensing patterns 12 are patterned in the form of a diamond. The first sensing patterns 11 and the second sensing patterns 12 are coupled in the first direction and the second direction, respectively, from a patterning process, or patterned in the form of a separated diamond to be coupled by additional bridge patterns.

According to an embodiment described above, the active tough region on the screen is divided into a plurality of regions and coupling between the conductive sensing patterns 11 and 12 is broken among the divided regions. This embodiment of divided regions is unlike a common electrostatic capacity touch screen.

Therefore, although the electrostatic capacity type touch screen is enlarged, increase in the base capacitance is prevented so that it is possible to prevent touch sensitivity from deteriorating.

The base capacitance, according to the embodiment described above, is not a touch capacitance intended for realizing the touch screen, but a parasitic capacitance necessarily generated in the structure. The other elements of a display panel positioned below the touch screen, such as a cathode electrode formed on the front surface of an organic light emitting display panel, a common electrode formed on the front surface of a liquid crystal display (LCD) panel, and parasitic capacitance generated between the sensing patterns 11 and 12 are the main elements of the base capacitance.

In addition, the auxiliary element of the base capacitance is the parasitic capacitance generated between the grounded signal lines and the conductive sensing patterns 11 and 12 of the display panel.

The touch capacitance intended for realizing the touch screen panel is a capacitance changed by a touch event. The touch event is generated and used for detecting a position.

Therefore, the touch sensitivity of the touch screen panel increases as the base capacitance is small and the touch capacitance is large.

When the touch screen is enlarged in a common electrostatic capacity type touch screen, the length by which the conductive sensing patterns 11 are coupled to each other and the length by which the conductive sensing patterns 12 are coupled to each other increases so that the base capacitance increases and the touch sensitivity deteriorates.

In the electrostatic capacity type touch screen according to the embodiments described above, the active touch region is divided into a plurality of regions. The plurality of regions allow for coupling of the conductive sensing patterns 11 and 12 among the divided regions to be broken. Thus, the increase in the base capacitance is prevented so that it is possible to prevent the touch sensitivity from deteriorating.

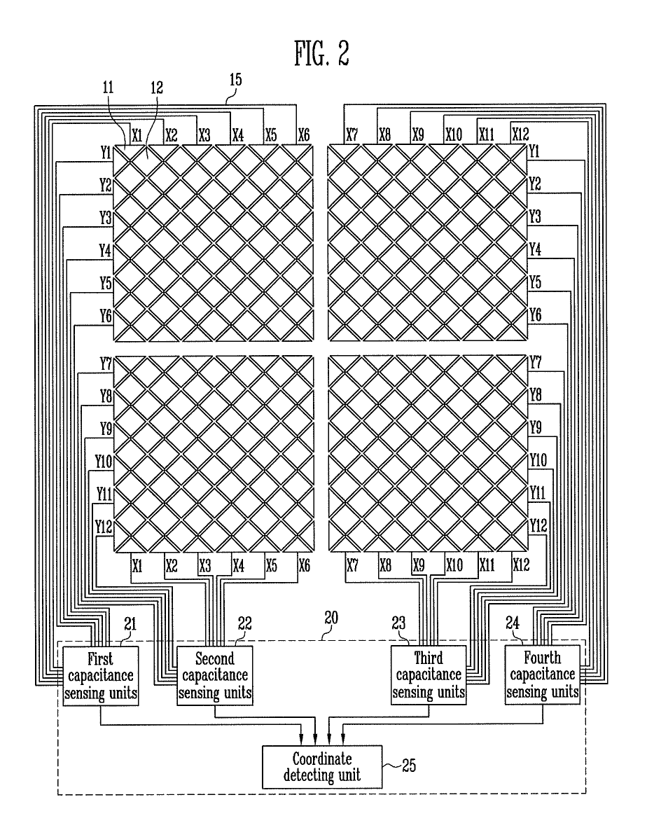

A method of detecting the position of the touch point using the electrostatic capacity type touch screen according to an embodiment will be described with reference to FIG. 2. FIG. 2 is a block diagram illustrating the position detecting apparatus of the touch screen of FIG. 1 according to an embodiment.

Referring to FIG. 2, a touch screen position detecting apparatus 20 according to an embodiment includes a plurality of capacitance sensing units 21 to 24 for sensing the capacitances of the divided regions and a single coordinate detecting unit 25 for collecting the capacitance information output from the plurality of capacitance sensing units 21 to 24 to detect the position of the touch point.

The plurality of capacitance sensing units 21 to 24 are provided in the position detecting apparatus 20 so that the divided regions may independently detect the capacitance.

For example, the active touch region on the screen is divided into two up and down and side to side regions, respectively. Therefore, four regions are obtained, a first capacitance sensing unit 21 for detecting capacitance in the left uppermost region, a second capacitance sensing unit 22 for detecting capacitance in the left lowermost region, a third capacitance sensing unit 23 for detecting the capacitance in the right lowermost region, and a fourth capacitance sensing unit 24 for detecting capacitance in the right uppermost region may be provided.

The capacitance sensing units 21 to 24 are coupled to the conductive sensing patterns 11 and 12 in the respective regions through conductive lines 15. The conductive lines 15 are coupled to channels (that is, in a column line and a row line) in the first direction and the second direction in the corresponding regions to sense the capacitances in the corresponding regions. The capacitance sensing units 21 to 24 output the digital values corresponding to the sensed capacitances to a coordinate detecting unit 25.

Therefore, the capacitance sensing units 21 to 24 may sense the capacitances in the respective regions into digital values or may sense the capacitances into analog values. If the capacitance sensing units 21 to 24 sense the capacitances into analog values, the capacitance sensing units 21 to 24 may convert the analog values into digital values through an analog-to-digital converter ADC to output the converted values.

The coordinate detecting unit 25 synthesizes the digital values output from the capacitance sensing units 21 to 24 to correctly calculate the coordinate values of the touch point.

When a finger or an object such as a touch stick contacts the above described touch screen, capacitances of the conductive sensing patterns 11 and 12 change, and the changes are sensed by the capacitance sensing units 21 to 24. The capacitance sensing units 21 to 24 then convert into the digital values and to be output to the coordinate detecting unit 25. The coordinate detecting unit 25 synthesizes the digital values output from the capacitance sensing units 21 to 24 to calculate the coordinate values of the touch point.

The position detection is collectively performed by the coordinate detecting unit 25, through the calculation of the coordinate values of the touch point. Thus, the error of the position detection may be prevented and the accuracy of the position detection may be improved.

Conventionally, the capacitances of the respective regions are sensed and the coordinate values are independently calculated. In this scenario, when a touch event is generated in one point position on the boundary between two regions, the touch event is erroneously recognized as two touch events generated at the edges of two regions. The recognition of two touch events generated at the edges of two regions is erroneous position detection. However, according to an embodiment, when the active touch region is divided, the coordinate values are collectively calculated by one coordinate detecting unit 25. Thus, errors in the position detection may be prevented and the accuracy of the position detection may be improved.

According to the above embodiment, in order to sense the capacitances of the divided regions, the plurality of independently coupled capacitance sensing units 21 to 24 are adopted by the respective regions. However, the present embodiment is not limited to the above configuration.

For example, similar to the coordinate detecting unit 25, only one capacitance sensing unit may be provided and the capacitance sensing unit may sense the capacitances of the respective regions by time division driving.

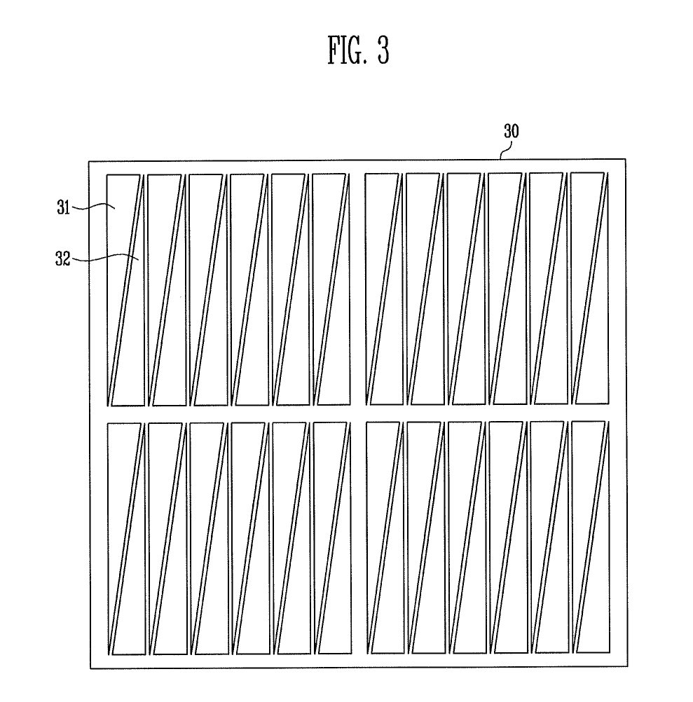

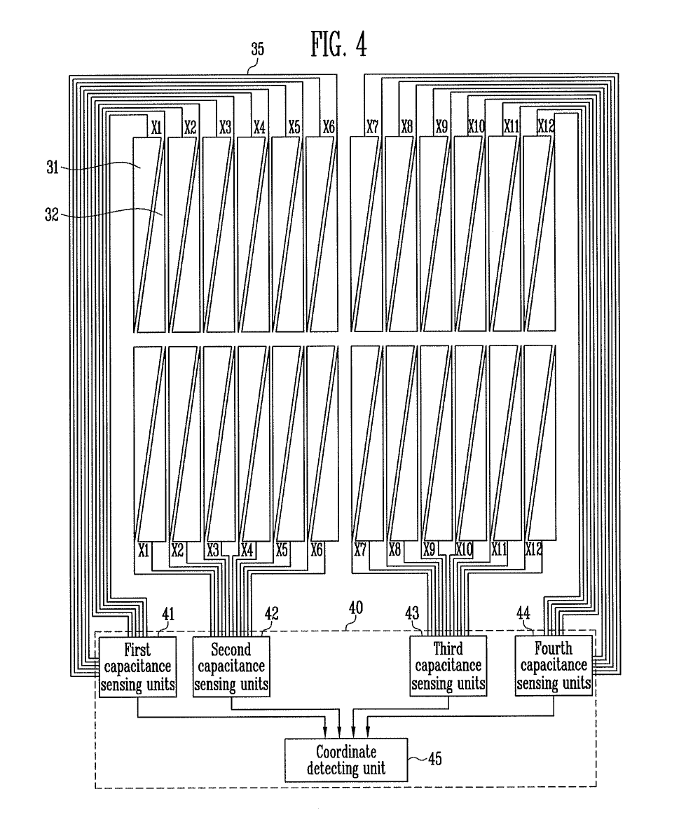

FIG. 3 is a schematic plan view illustrating an electrostatic capacity type touch screen according to another embodiment. FIG. 4 is a block diagram illustrating the position detecting apparatus of the touch screen of FIG. 3.

When FIGS. 3 and 4 are described, detailed description of the same or similar parts of FIGS. 1 and 2 will be omitted.

Referring to FIGS. 3 and 4, the electrostatic capacity type touch screen, according to another embodiment, includes a transparent substrate 30 and a plurality of conductive sensing patterns 31 and 32 formed on the transparent substrate 30.

Here, the conductive sensing patterns 31 and 32 are realized as a plurality of triangle bar electrode pairs arranged to face each other, to cross each other, and to be engaged with each other. The plurality of triangle bar electrode pairs lie in the first direction and are repeatedly arranged in the second direction. For example, the plurality of triangle bar electrode pairs lie in a column direction and may be repeatedly arranged in a row direction. However, the present embodiment is not limited to the above configuration. The plurality of triangle bar electrode pairs may lie in the row direction and may be repeatedly arranged in the column direction.

In the electrostatic capacity type touch screen according to another embodiment, the positions of the coordinates of the X axis are previously determined in the triangle bar electrode pairs. When a touch event is generated, the coordinates of the Y axis are grasped by a change in electrostatic capacity in accordance with the contact area ratio of the triangle bar electrodes.

The electrostatic capacity type touch screen according to the present embodiment is in the form of tiling. The form of tiling is similar to the embodiments of FIGS. 1 and 2, in which the active touch region on the screen is divided into a plurality of regions and coupling of the conductive sensing patterns 31 and 32 in the divided regions is broken.

The capacitances of the divided region are sensed by the plurality of capacitance sensing units 41 to 44 and the position of the touch point is detected by one coordinate detecting unit 45.

By way of summation and review, according to embodiments described above, the active touch region on the screen is divided into a plurality of regions and coupling of the conductive sensing patterns is broken among the divided regions so that the electrostatic capacity type touch screen realized in a tiling type is provided. Therefore, it is possible to prevent the base capacitance from being increased by the touch screen being enlarged so that it is possible to prevent the touch sensitivity of the electrostatic capacity type touch screen from deteriorating.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electrostatic capacity type touch screen, comprising:
an active touch region on a screen, the active region being divided into a plurality of regions; and
a plurality of conductive sensing patterns formed in the divided regions to detect capacitance,
wherein coupling of the conductive sensing patterns among the divided regions is broken.

2. The electrostatic capacity type touch screen as claimed in claim 1, further comprising:
a plurality of capacitance sensing units for sensing capacitances of the divided regions; and
a coordinate detecting unit for collecting capacitance information output from the plurality of capacitance sensing units to detect a position of a touch point.

3. The electrostatic capacity type touch screen as claimed in claim 2,
wherein the plurality of capacitance sensing units sense capacitances of corresponding regions to output as digital values, and
wherein the coordinate detecting unit synthesizes the digital values output from the capacitance sensing units to calculate coordinate values of a touch point.

4. The electrostatic capacity type touch screen as claimed in claim 1, wherein the conductive sensing patterns comprise:
a plurality of first sensing patterns coupled in the divided regions in a first direction; and
a plurality of second sensing patterns coupled in the divided regions in a second direction.

5. The electrostatic capacity type touch screen as claimed in claim 4,
wherein the first sensing patterns have a plurality of diamond patterns coupled to each other in the first direction, and
wherein the second sensing patterns have a plurality of diamond patterns coupled to each other in the second direction.

6. The electrostatic capacity type touch screen as claimed in claim 1, wherein the conductive sensing patterns are realized by a plurality of triangle bar electrode pairs arranged to face each other, to cross each other, and to be engaged with each other.
